(19) United States
(12) Patent Application Publication
(10) Pub. No.: US 2006/0036449 A1
(43) Pub. Date: Feb. 16, 2006

(54) Attendant circumstance utilization device

(76) Inventors: Shouichi Araki, Osaka-shi (JP); Hiroshi Kutsumi, Moriguchi-shi (JP); Atsushi Yoshida, Neyagawa-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/535,195

(22) PCT Filed: Nov. 20, 2003
(86) PCT No.: PCT/JP03/14775

§ 371 Date: May 17, 2005

(30) Foreign Application Priority Data
Nov. 22, 2002 (JP) 2002-338984

(51) Int. Cl. G06Q 99/00

(52) U.S. Cl. 705/1

(57) ABSTRACT

An attendant circumstance utilization device provides a function of equipment and a content appropriate to a user by considering the attendant circumstance by whom the user is accompanied, and includes an attendant ID detecting unit (101) to detect an attendant information (attendant ID) indicating by whom the user is accompanied and an equipment operation detecting unit (103) to detect an equipment operation. A history data of an attendant ID is stored in an attendant ID database (102) and a history data of an equipment operation is stored in an operation history database (104) respectively by correlating with a time of detection. An equipment operation activity particular to the user who was accompanied by the current attendant in the past time is judged by an attendant circumstance dependent operation activity judging unit (105) based on the attendant ID newly detected by the attendant ID detecting unit (101), the history data of the attendant ID in the attendant ID database (102) and the equipment operation history data in the operation history database (104). A function/content providing unit (106) provides the user with a function of equipment and a content depending on the particular equipment operation activity.

### TECHNICAL FIELD

The present invention relates to techniques to change a function of equipment, a content or a service providing to the user depending on by whom the user is accompanied.

### BACKGROUND ART

In recent years, there is a known technique which provides a user with relevant services depending on the user's circumstances by executing sensing of user's circumstances such as location. For instance, the currently available technique determines the current location of the user sequentially by way of the base stations for Global Positioning System (GPS) and Personal Handyphone System (PHS), gyro sensor and the like, and predicts the likely area of traveling referring to the user's traveling history data and then provides relevant service information of the area. (For example, a technique described in Japanese Laid-Open Patent Application No. 2000-293540)

However the conventional technique above enables only to provide services which suit to user's usual activities by referring to information on when, where and what the user has used. And the user's activities are not always determined based on the preferences. The “attendant circumstance”, therefore, needs to be considered to provide the most appropriate services. The attendant circumstance of the user means that by whom the user is accompanied. (Someone with a user is called as “an attendant” or “a companion”.)

### DISCLOSURE OF INVENTION

The present invention has been conceived in view of the above problem, and it is an object of the present invention to provide an attendant circumstance utilization device which provides a user with the most appropriate function of equipment, content or service depending on the user's attendant circumstance considering above-mentioned point.

In order to achieve the above-mentioned object, the attendant circumstance utilization device related to the present invention is a device for providing a user with services including provision of information and rendering of a service. And the device is characterized in that the device includes an attendant detecting unit for detecting an attendant accompanying the user and a service providing unit for determining a service based on the detected attendant and for providing the user with the determined service. Accordingly it is possible for the user to receive the most appropriate service particular to the user with an attendant.

Now the attendant circumstance utilization device further includes an equipment operation detecting unit for detecting an equipment operation performed by the user, a storing unit for storing a history data of the detected equipment operation and attendant information indicating the attendant detected by the attendant detecting unit when the user performs the equipment operation, the history data being associated with the attendant information, and a judging unit for judging an equipment operation activity particular to a case, where the user is accompanied by the same attendant at a present time and in a past time, based on the attendant newly detected by the attendant detecting unit and the equipment operation history data stored in the storing unit, and the service providing unit may provide the user with a service depending on the particular equipment operation activity. Accordingly it is possible for the user to receive the most appropriate service depending on the equipment operation that performed frequently by the user accompanied by the attendant in the past.

And the attendant circumstance utilization device further includes a location detecting unit for detecting a current location of the user, a storing unit for storing a traveling history data of the user based on the detected current location and the attendant information indicating the attendant detected by the attendant detecting unit when the user performs the traveling, the history data being associated with the attendant information, and a judging unit for judging a destination particular to a case, where the user is accompanied by the same attendant at a present time and in a past time, based on the user's current location newly detected by the location detecting unit, an attendant newly detected by the attendant detecting unit and a traveling history data stored in the storing unit, and the service providing unit may provide the user with services depending on the particular destination. Accordingly it is possible for the user accompanied by the attendant to obtain the information, which is related to the place where the user and the attendant frequently visited in the past, before the user and the attendant arrive the place.

The attendant circumstance utilization device further includes a service detecting unit for detecting a service which the user utilizes, a storing unit for storing the detected service utilization history data and the attendant information indicating the attendant detected by the attendant detecting unit when the user utilizes the service, the history data being associated with the attendant information, and a judging unit for judging a service utilization particular to a case, where the user is accompanied by the same attendant at a present time and in a past time, based on the attendant newly detected by the attendant detecting unit and the utilization history data stored in the storing unit, and the service providing unit may provide the user with service depending on the particular service utilization. Accordingly it is possible for the user accompanied by the attendant to automatically receive the service related to the service utilized frequently by the user and the attendant in the past.

And the attendant circumstance utilization device further includes a service detecting unit for detecting a service utilized by the user, an attendant category detecting unit for detecting a category of the attendant, a storing unit for storing a detected service utilization history data and a category information indicating a category detected by the attendant category detecting unit when the user utilizes a service, the history data being associated with the category information, and a judging unit for judging a service utilization particular to a case, where a category of an attendant accompanying the user is the same at a present time and in a past time, based on a category newly detected by the attendant category detecting unit and the utilization history data stored in the storing unit, and the service providing unit may provide the user with a service depending on the particular service utilization. Accordingly it is possible for the user accompanied by the attendant to receive the most appropriate service depending on the category of the attendant.

And the attendant circumstance utilization device further includes the number of attendants detecting unit for detecting the number of attendants, a service detecting unit for detecting a service which the user utilizes, a storing unit for storing a utilization history data of the detected service and a number information indicating the number detected by the number of attendants detecting unit when the user utilizes the service, the history data being associated with the number information, and a judging unit for judging a service utilization particular to a case where the number of attendants accompanying the user is the same at a present time and in a past time, based on a newly detected number by the number of attendants detecting unit and the utilization history data stored in the storing unit, and the service providing unit may provide the user with a service depending on the particular service utilization. Accordingly it is possible for the user accompanied by the attendant to receive the most appropriate service depending on the number of attendants.

As mentioned above, according to the present invention, an attendant information detecting unit to detect the attendant information, that indicates by whom the user is accompanied, is included, and it is possible to provide the user with the most appropriate function of equipment, a content and a service as it is determined to provide the function of the equipment, the content and the service particular to the user's activities by the judgment of the user's activities particular to the user with the attendant at present and in the past based on the attendant information history data, the equipment operation history data of the user, the traveling history data and the service utilization history data.

Furthermore the present invention is not only realized as the attendant circumstance utilization device described above, but also it is realized as the attendant circumstance utilization device using the constituent elements as steps, and also realized as a program executed by such as personal computer, and as a computer readable recording medium which records such program.

### BRIEF DESCRIPTION OF DRAWINGS

FIG. 1 is a block diagram showing an overall configuration of a system according to the present invention.

FIG. 2 is a block diagram showing an attendant circumstance utilization device in a first embodiment of the present invention.

FIG. 3 is a flowchart showing the operation in the first embodiment of the present invention.

FIG. 4 is a flowchart showing the detailed processes of the operation of FIG. 3.

FIG. 5 is a diagram showing an example of history descriptors.

FIG. 6 is a diagram showing an example of equipment operation history data including an attendant.

FIG. 7A is a diagram showing an example of a screen display for DTV in the case where a user is accompanied by a friend, FIG. 7B is a diagram showing an example of a screen display for DTV in the case where the user is accompanied by a lover, and FIG. 7C is a diagram showing an example of a screen display for DTV in the case where the user is accompanied by a child.

FIG. 8 is a block diagram showing an attendant circumstance utilization device in a second embodiment of the present invention.

FIG. 9 is a flowchart showing the operation in the second embodiment of the present invention.

FIG. 10 is a flowchart showing the detailed processes of the operation of FIG. 9.

FIG. 11 is a diagram showing an example of traveling history data with an attendant.

FIG. 12A is a diagram showing an example of a screen display of a cellular phone, and FIG. 12B is a diagram showing an example of a screen display of a car navigation system.

FIG. 13 is a block diagram showing an attendant circumstance utilization device in a third embodiment of the present invention.

FIG. 14 is a flowchart showing the operation in the third embodiment of the present invention.

FIG. 15 is a flowchart showing the detailed processes of the operation of FIG. 14.

FIG. 16 is a diagram showing an example of service utilization history data with an attendant.

FIG. 17 is a diagram showing an example of a screen display of a cellular phone.

FIG. 18 is a block diagram showing an attendant circumstance utilization device in a fourth embodiment of the present invention.

FIG. 19 is a flowchart showing the operation in the fourth embodiment of the present invention.

FIG. 20A is a diagram showing a case when a coupon for a pub is delivered to a cellular phone, and FIG. 20B is a diagram showing a case when a coupon for an amusement park is delivered to a cellular phone.

FIG. 21 is a block diagram showing an attendant circumstance utilization device in a fifth embodiment of the present invention.

FIG. 22 is a flowchart showing the operation in the fifth embodiment of the present invention.

FIG. 23 is a diagram showing an example of a screen display of a cellular phone.

FIG. 24 is a diagram showing an example of a configuration for an attendant circumstance utilization device of the present invention.

### BEST MODE FOR CARRYING OUT THE INVENTION

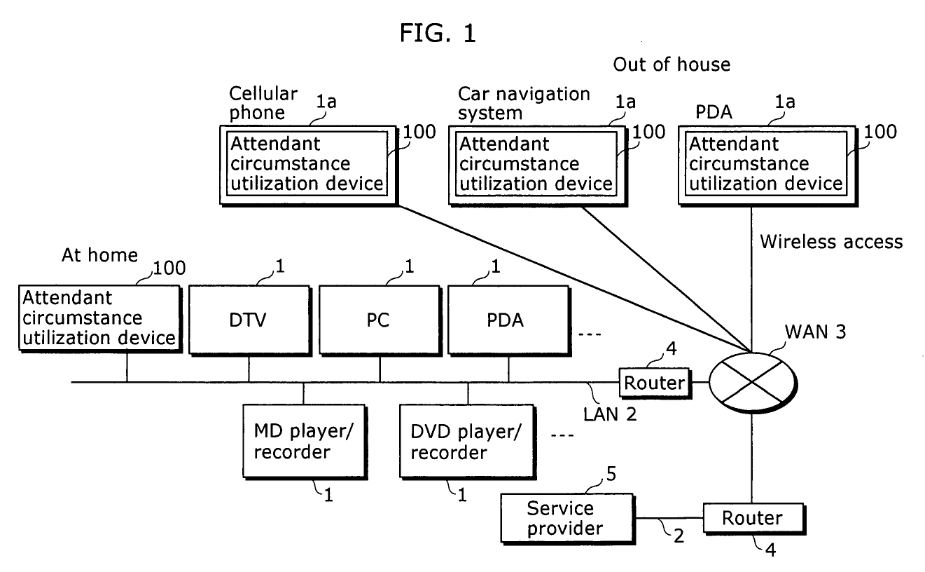

FIG. 1 is a block diagram showing an overall configuration of the system according to the present invention. The system has: home electronics 1, which can be connected to a network, including such as a Digital Television (DTV), a Personal Computer (PC), a Personal Digital Assistance (PDA, personal portable information terminal), a MD Player/Recorder, a DVD player/recorder; user terminals 1a, which can be connected to a network in mobile environment, including such as a cellular phone, a car navigation system and a PDA; a Local Area Network 2 (LAN) and a Wide Area Network 3 (WAN, for example for Internet) which are configured by wired or wireless network; routers 4 for connecting LAN 2 to WAN 3; and a service provider 5 for providing services to the home electronics 1 at home and the user terminal 1a out of house through a router 4. The attendant circumstance utilization device 100 provides functions of equipment, contents and services depending on by whom the user is accompanied. The attendant circumstance utilization device 100 at home is connected to LAN 2 together with different home electronics 1. And also the attendant circumstance utilization device 100 is mounted in each user terminal 1a.

Hereinafter, the first through the fifth embodiments related to the attendant circumstance utilization device 100 in FIG. 1 will now be described.

### The First Embodiment

In the first embodiment, it is considered to provide the user and an attendant with the most appropriate equipment settings and contents by specifying the equipment operation activity particular to the user with the attendant.

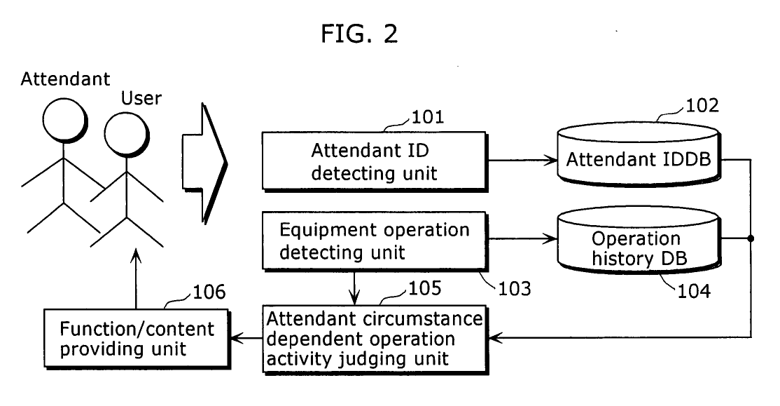

The configuration of the attendant circumstance utilization device 100 in the first embodiment is shown in FIG. 2. The attendant circumstance utilization device 100 in FIG. 2 includes an attendant ID detecting unit 101, an attendant ID database 102, an equipment operation detecting unit 103, an operation history database 104, an attendant circumstance dependent operation activity judging unit 105 and a function/content providing unit 106. For example the attendant ID detecting unit 101 detects the attendant information (attendant ID) indicating by whom the user is accompanied during the operation of the home electronics 1. The attendant ID database 102 stores the history data of the detected attendant ID. The equipment operation detecting unit 103 detects an equipment operation. The operation history database 104 stores the detected equipment operation history data. The attendant ID history data is associated with the equipment operation history data each other by the time of detection. The attendant circumstance dependent operation activity judging unit 105 judges the equipment operation activities, which are particular to the user when the user was accompanied by the current attendant in past times. The judgment is executed based on the attendant ID newly detected by the attendant ID detecting unit 101, the history data of the attendant ID stored in the attendant ID database 102 and the equipment operation history data stored in the operation history database 104. The function/content providing unit 106 provides the user with functions of equipment and contents depending on the particular equipment operation activities.

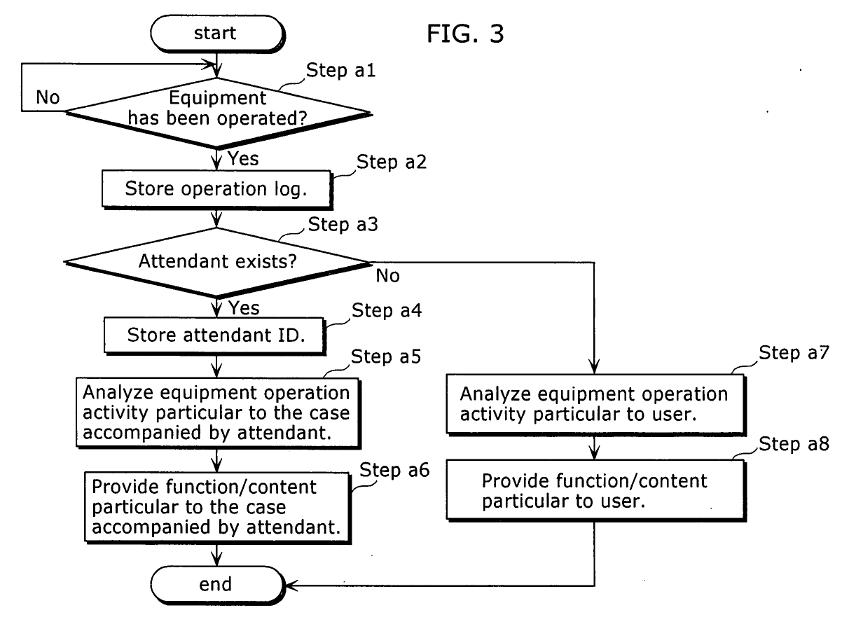

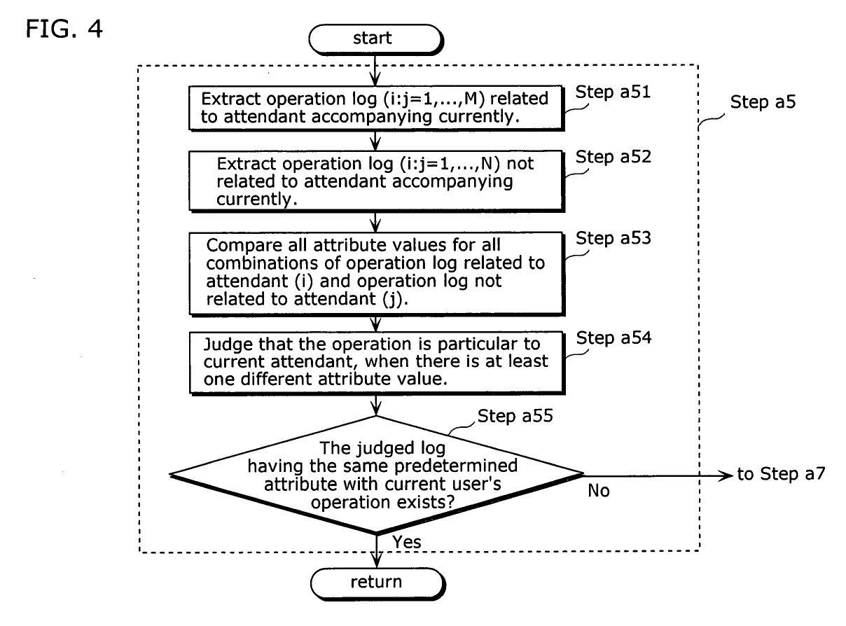

The operation in the first embodiment configured as above now will be described using the flowcharts in FIG. 3 and FIG. 4.

Step a1 in FIG. 3 is a detecting step of equipment operation. The equipment operation detecting unit 103 detects the equipment operation. If the equipment operation is detected, the operation proceeds to Step a2. Unless any equipment operation is detected, the device remains on standby status for equipment operation.

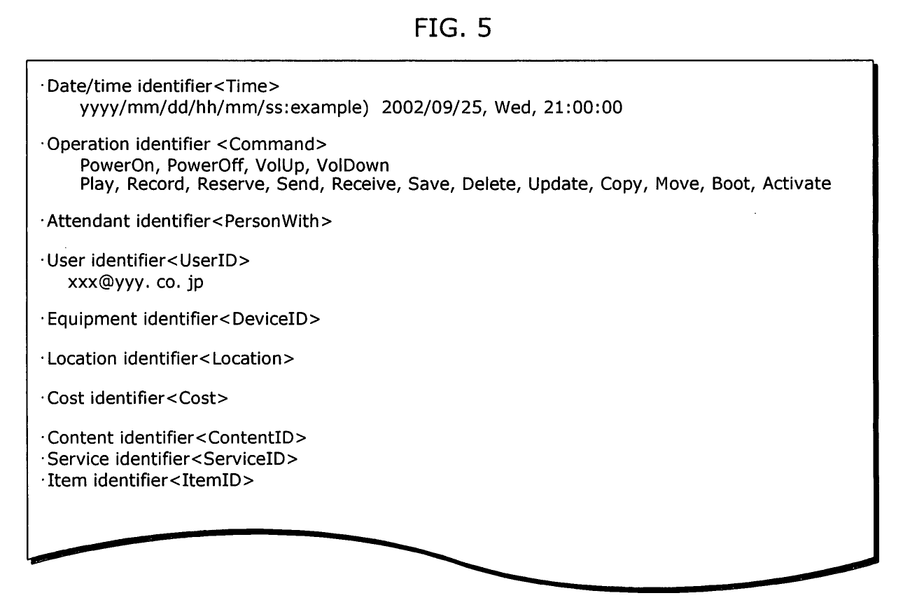

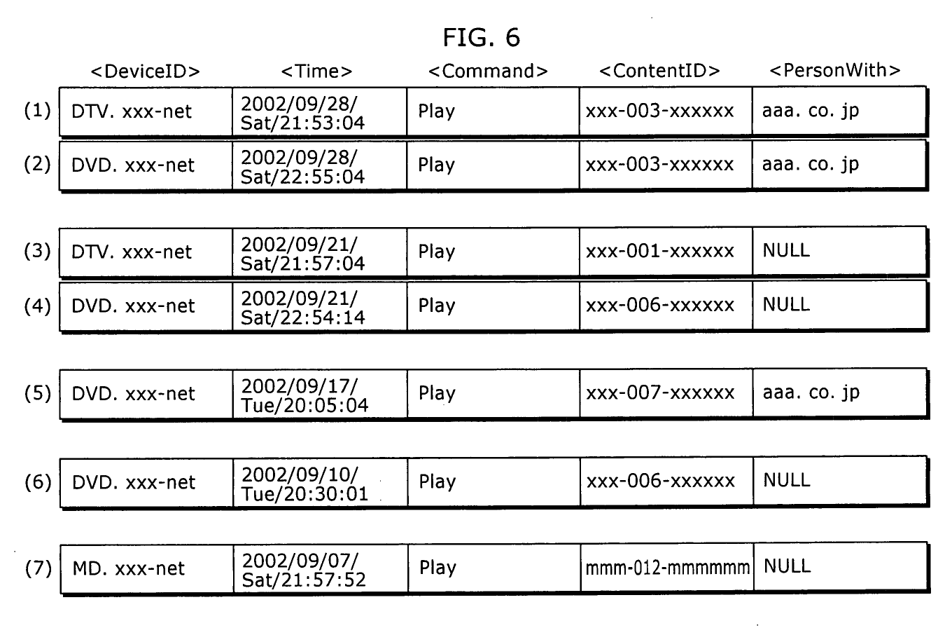

Step a2 is a storing step of an equipment operation log. The operation detected in Step a1 is stored in the operation history database 104. FIG. 5 shows an example of history descriptors. In the operation history database 104, the operation history data such as (<DeviceID>, <Time>, <Command> and <ContentID>) shown in FIG. 6 are stored. Note that the history descriptors shown in FIG. 5 are commonly used in the first through the fifth embodiments.

Step a3 is a detecting step of an attendant. The attendant ID detecting unit 101 detects existence or nonexistence of an attendant. If the user has an attendant, the operation proceeds to Step a4. Unless the user has any attendant, the operation proceeds to Step a7. When the attendant, for example, carries a wireless equipment connectable to a network such as PDA, it is possible to identify the attendant (or the attendant's belongings) by means of Media Access Control (MAC) address of a wireless LAN card. In order to detect that the attendant is located closer to the user, the ID information such as the mail address can be exchanged with the user by local wireless.

Step a4 is a recording step of an attendant ID. The detected attendant information in Step a3 is stored in the attendant ID database 102 by associating with the operation log stored in the operation history database 104 by the detected time as shown in <PersonWith> in FIG. 6. For example, the history data (1) in FIG. 6 represents that the user watches (<Command> play) a program content (<ContentID> xxx-003-xxxxx) at the time (<Time>2002/09/28/Sat/21:53:04) on DTV (<DeviceID> DTV.xxx-net) with an attendant (<PersonWith> aaa.co.jp). The segment shown in numbers in <ContentID>, i.e. “003” in history data (1), represents the genre number. The program genre information such as Electronic Program Guide (EPG) is encoded into the number. The “NULL” in <PersonWith> means that the user is unaccompanied.

Step a5 is a step for analyzing equipment operation activities which are particular to the case where the user is accompanied by an attendant. The attendant circumstance dependent operation activity judging unit 105 analyzes the history data related to the detected attendant ID, and specifies user's particular operation activities in the case where the user is with an attendant, and then the operation proceeds to Step a6. For example, the history data (1), (2) and (5) are user operation logs in the case where the user is accompanied by an attendant “aaa.co.jp” in FIG. 6, and it is obvious that the genre numbers 003 and 007 in <ContentID> are particular to the attendant. More specifically, although the history data (3) and (4) are the same day of the week and the same hour with the history data (1) and (2), the user watches the contents of genre numbers 001 and 006 in the case where the user is unaccompanied by the attendant “aaa.co.jp”. Additionally, although the history data (6) is the same day of the week and the same hour with the history data (5), the user watches the content of the genre number 006 in the case where the user is unaccompanied by the attendant “aaa.co.jp”. Accordingly, particular content information is specified when a user is accompanied by an attendant. Similarly the equipment operation particular to the case where the user is accompanied by an attendant can be specified. The sequence of Step a5 will be described further in another section hereinafter.

Step a6 is a step for providing particular functions and contents in the case where the user is accompanied by an attendant. The functions and contents related to particular equipment operation activities specified in Step a5 are provided. For example, if the user usually watches action movies in the case where the user is accompanied by a friend at home, action movies are recommended out of the stored programs that are prerecorded using keyword selection. Similarly, when the user is accompanied by a lover, the movies in a genre frequently watched are recommended. And in the case where the user is accompanied by a child, the setting is changeable for the equipment to automatically skip channels with contents including such as violence when the user operates a remote control of DTV.

Step a7 is a step for analyzing equipment operation activities particular to the user in the case where the user is unaccompanied by attendant. The attendant circumstance dependent operation activity judging unit 105 specifies the equipment operation activity particular to the user, and then the operation proceeds to Step a8. The equipment operation activity particular to the user is specified by choosing the attendant attribute <PersonWith> being “NULL” and judging the operation activity as a related operation log when the number of identical attribute values for “current user operation log” and “past user operation log” reach to a predetermined number by comparing the values. In the example in FIG. 6, it is obvious that the user prefers to watch the content in the genre 006 from the history data (4) and (6), and prefers to listen to the music in the genre 012 with MD player/recorder (<DevideID> MD.xxx-net) from the history data (7), when the user is unaccompanied. Hence, for example, in the case where the current operation log <DeviceID> is “DVD.xxx-net”, the history data (4) is chosen, and where the current operation log is “MD.xxx-net”, the history data (7) is chosen. When there are plural chosen history data, the history data with higher frequency for attribute value may be chosen. Alternatively, plural recommendations may be offered for user's choice.

Step a8 is a step for providing functions and contents particular to the user. Since the user is unaccompanied, the functions and contents related to equipment operation activity particular to the user are provided. Since the user browses the contents in the genre number 001 and number 006 in the history data (3), (4) and (6) in FIG. 6, TV programs and DVD software in the same genre, therefore, are recommended to the user.

The procedure to specify the equipment operation activity particular to the case where the user is accompanied by an attendant in the above-mentioned Step a5 will now be described using the flowchart in FIG. 4. The processing below is all performed by the attendant circumstance dependent operation activity judging unit 105. The processing in FIG. 4 is subject to be executed after the existence of an attendant is confirmed in Step a3 in FIG. 3.

Step a51 is a step for extracting operation logs related to the current attendant. The operation log of an identical attribute value <PersonWith> with the attendant information detected in Step a3 in FIG. 3 is chosen out of operation logs stored in the operation history database 104 based on the attendant ID history data in the attendant ID database 102. For example, when the user is accompanied by an attendant “aaa.co.jp” again, the history data (1), (2) and (5) in FIG. 6 are chosen and the number M is three.

Step a52 is a step for extracting operation logs not related to the current attendant. The operation log of the attendant attribute <PersonWith> not including the attendant information detected in Step a3 in FIG. 3 is chosen out of the operation logs stored in the operation history database 104 based on attendant ID history data in the attendant ID database 102. For example the history data (3), (4), (6) and (7) are chosen in FIG. 6 and the number N is 4.

Step a53 is a step for comparing the attribute values between operation logs. All of the attribute values are compared about the attributes other than attendant attribute on all combinations (3×4=12 combinations in this case) of M pieces of “operation logs related to the current attendant” extracted in Step a51 and N pieces of “operation logs not related to the current attendant” extracted in Step a52. In the example in FIG. 6, the comparisons are performed on <DeviceID>, <Time>, <Command> and <Content ID>. The comparison on the attribute <Time> may be performed for identical match in “time frame” (for example between 21 and 22 o'clock) and “day of the week” or the comparison may be performed by considering “a predetermined range of time difference is regarded as identical (for example ±10 min.)”.

Step a54 is a step for judging operation logs particular to the current attendant. The operation log is judged as an “operation log particular to the current attendant”, in the case where the operation log is judged that at least one of the attribute values is different in the attribute value comparison in Step a53, out of M pieces of “operation logs related to the current attendant” extracted in Step a51. In FIG. 6, for example, the history data (1), (2) and (5) are judged as the operation log particular to the current attendant from the deference in <ContentID>.

Step a55 is a step for judging an operation log related to the current user operation. In Step a54, the operation log related to the current user operation is chosen out of the operation logs judged as an “operation log particular to the current attendant”. More specifically, the operation log is judged as a related operation log in the case where the amount of identical attribute values reach to the predetermined number by comparing the attribute values of “operation log particular to the current attendant” and the attribute values of “operation log for the current user”. In FIG. 6, for example, when the DTV is turned on, the history data (1), when “DTV.xxx-net” in <DeviceID> is identical, is chosen and the channel for a program in genre 003 of the particular <ContentID> is automatically chosen. In this case, not only the matching of <DeviceID> but also the matching of attribute values such as <Time> and <Command> are judged, and more appropriate functions and contents to the condition are recommended. For example, when the user operates a DVD player/recorder, the related history data are (2) and (5). When the day of the week in <Time> is considered, if it is Tuesday now, the history data (5) is chosen and the contents in genre 007 may be recommended. This method of recommendation shows just an example. Unless there is a corresponding day of the week, the genre 003 with higher browsing frequency may be recommended, or all of the contents related to the genre may be recommended for user's choice. When there are operation logs related to the current user operation, the operation proceeds to Step a6 in FIG. 3. Unless there is an operation log related, the operation proceeds to a7.

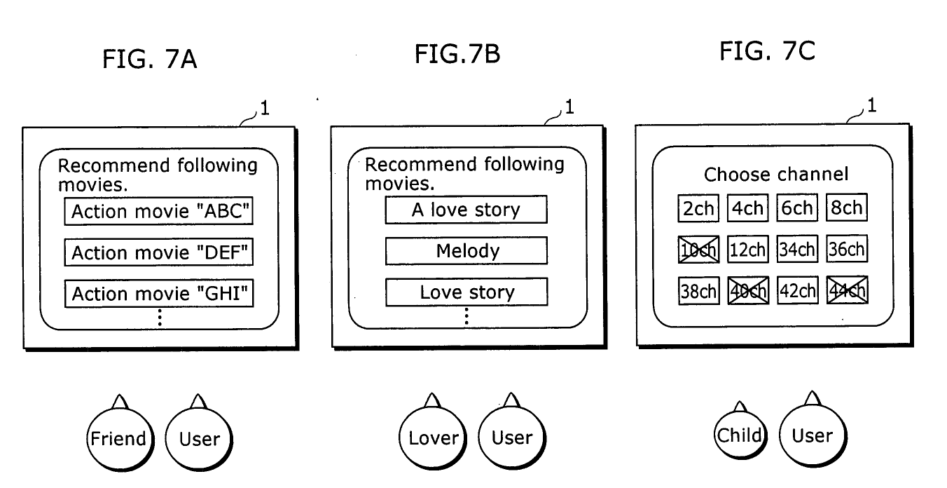

As described hereinbefore, according to the first embodiment, at the moment when the user meets an attendant, the most appropriate equipment setting and the contents involving the attendant can be provided by specifying the equipment operation which is particular to the case where the user is accompanied by the attendant. For example, as the screen display of DTV1 shown in FIG. 7, if the user chooses the menu of program recommendation, when the user is accompanied by a friend, a recommendation display of action movies is shown, which the user has frequently seen with the friend (FIG. 7A). When the user is accompanied by a lover, romantic movies which the user has frequently seen with the lover are recommended in the recommendation display (FIG. 7B), and when the user is accompanied by a child, programs excluding adult-themed programs are shown on the recommendation display (FIG. 7C).

### The Second Embodiment

In the second embodiment, it is considered to provide the user and an attendant with the most appropriate services to the place where the user and the attendant are located, by specifying the traveling activity particular to the user with the attendant.

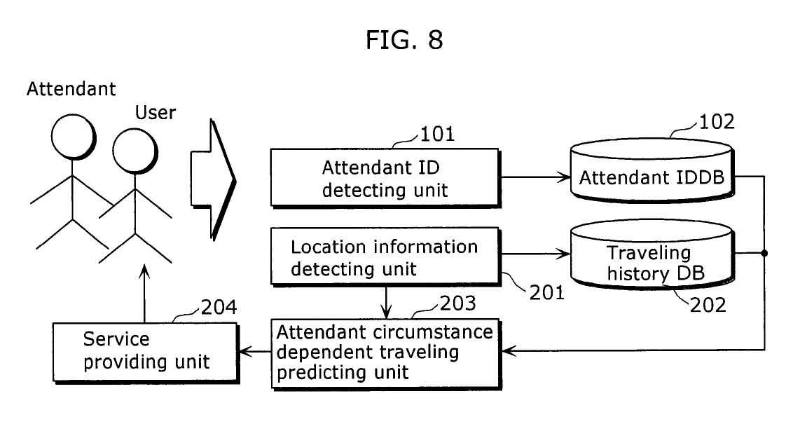

The configuration of the attendant circumstance utilization device 100 is shown in FIG. 8 for the second embodiment. The attendant circumstance utilization device 100 in FIG. 8 includes an attendant ID detecting unit 101, an attendant ID database 102, a location information detecting unit 201, a traveling history database 202, an attendant circumstance dependent traveling predicting unit 203 and a service providing unit 204. The attendant ID detecting unit 101 detects attendant information (attendant ID) indicating by whom the user, who is carrying the terminal 1a, is accompanied. The attendant ID database 102 stores the detected attendant IDs history data. The location information detecting unit 201 detects the current location of the user. The traveling history database 202 stores the detected traveling history data of the user. The attendant ID history data is associated with the user's traveling history data each other by the time of detection. The attendant circumstance dependent traveling predicting unit 203 judges the destination which is particular to the user with the current attendant in the past. The judgment is performed based on the attendant ID newly detected by the attendant ID detecting unit 101, the user's current location newly detected by the location information detecting unit 201, the history data of the attendant ID stored in the attendant ID database 102 and the traveling history data stored in the traveling history database 202. The service providing unit 204 provides the user with services depending on the particular destination.

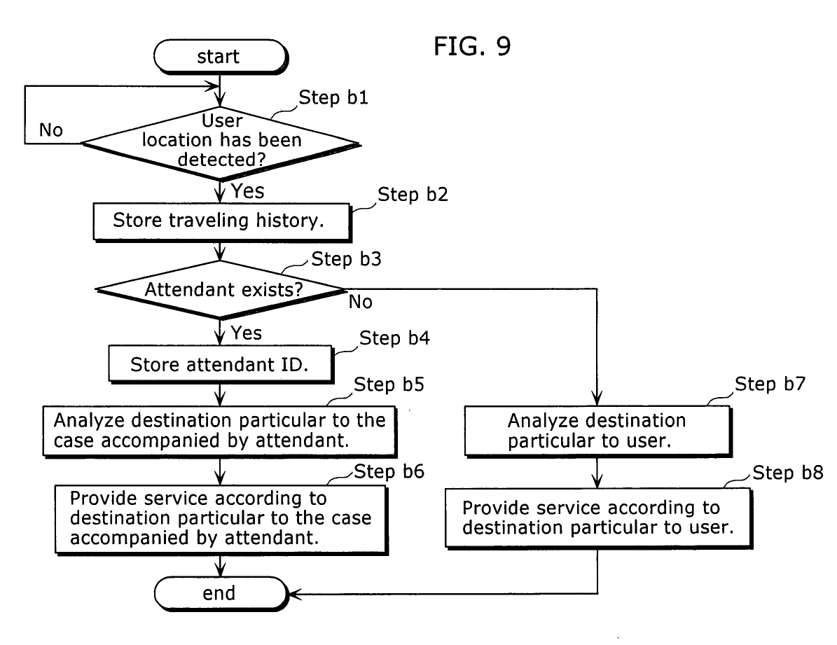

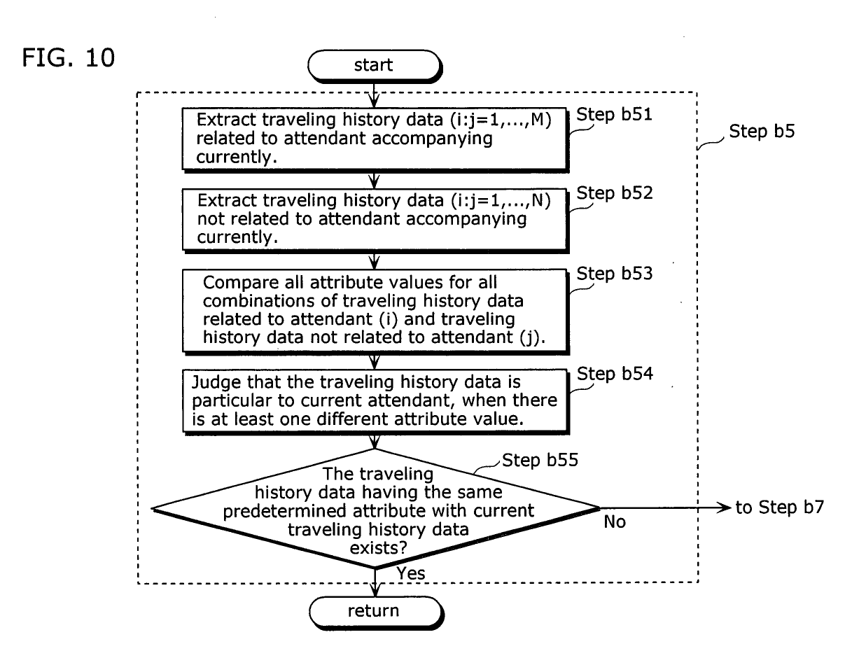

The operation in the second embodiment configured as above now will be described using the flowcharts in FIG. 9 and FIG. 10.

Step b1 in FIG. 9 is a step for detecting the user's location. The location information detecting unit 201 detects the location information (current location) of the user. The user's location by the detection is obtainable as, for example, the longitude and latitude information from GPS. Recently the user's location can be specified by cellular phone as well. When the user's location is detected, the operation proceeds to Step b2. Unless the location of the user is detected, the device remains on standby status for location detection.

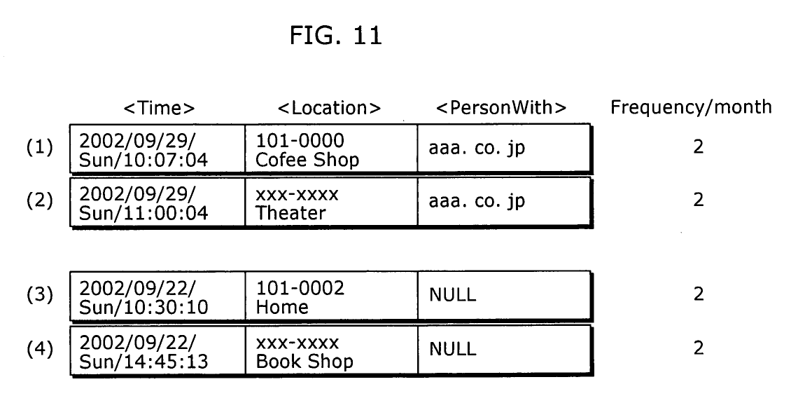

Step b2 is a step for storing the traveling history data. The location information detected in Step b1 is stored in the traveling history database 202. In this step, the location information is converted into addresses (for example postal code and so on) or landmarks (for example. department store, library, bookstore and so on) using geographical information, and is stored. FIG. 11 shows an example of history data (<Time> and <Location>) stored in the traveling history database 202.

Step b3 is a detecting step of an attendant. The attendant ID detecting unit 101 detects existence or non-existence of the attendant. When the user is accompanied by an attendant, the operation proceeds to Step b4. Unless the user has an attendant, the operation proceeds to Step b7. The ID information such as user and mail address may be exchanged for detecting the attendant information.

Step b4 is a step for storing an attendant ID. The attendant information detected in Step b3 is stored in the attendant ID database 102 by associating with the traveling history data stored in the traveling history database 202 using the time of detection as shown at <PersonWith> in FIG. 11. For example the history data (1) in FIG. 11 represents that the user is accompanied by an attendant (<PersonWith> aaa.co.jp) at a time (<Time>2002/09/29/Sun/10:07:04) at a location (<Location> CoffeeShop).

Step b5 is a step for analyzing the destination which is particular to the user with an attendant. The destination, which is particular to the user with an attendant with detected ID, is specified by the attendant circumstance dependent traveling predicting unit 203, and the operation proceeds to Step b6. For example, in FIG. 11, the history data (1) and (2) represent that the user has met with an attendant “aaa.co.jp” at a coffee shop (Coffee Shop) and gone to a cinema (Theater). In FIG. 11, “Frequency/Month” represents the frequency of the activities and it is shown that the user goes to a coffee shop and a cinema on Sunday twice a month. Step b5 will be described in another section hereinafter.

Step b6 is a step for providing services depending on the destination, which is particular to the user with an attendant. The service which is appropriate to the particular destination specified in Step a5 is provided. For example, a user terminal 1a searches through WAN 3 for the information related to the destination where the user frequently visits with the attendant, and presents it on the terminal. In the case where the user terminal 1a is a car navigation system, the necessary information at the destination with the attendant is searched and presented at the moment when the user gets on the car.

Step b7 is a step for specifying the destination particular to the user without an attendant. The destination particular to the user is specified by the attendant circumstance dependent traveling predicting unit 203, and the operation proceeds to Step b8. As for the destination particular to the user, “NULL” in attendant attribute <PersonWith> is chosen. The attribute values <Location> of the “current user's traveling history data” and the “past user's traveling history data” are compared and the identical history data are chosen. And then the traveling history data subsequent to the chosen traveling history data is judged as the next destination where the user visits afterward. In FIG. 11, the history data (3) and (4) show that the user stays at home in the morning, and goes to a bookstore in the afternoon on Sunday when the user is unaccompanied. For example, it is, therefore, predicted that the user goes to a bookstore afterward when it is detected that the user stays alone at home currently.

Step b8 is a step for providing appropriate services depending on the destination which is particular to the user. Since the user is unaccompanied, the information related to the destination particular to the user is provided.

Now the processing flow to specify the destination particular to the case where the user is accompanied by an attendant in Step b5 mentioned above will be described using the flowchart in FIG. 10. The processes below are all executed by the attendant circumstance dependent traveling predicting unit 203. The processing in FIG. 10 is subject to be executed after the existence of an attendant is confirmed in Step b3 in FIG. 9.

Step b51 is a step for extracting the traveling history data related to the current attendant. The traveling history data of an identical attribute value <PersonWith> with the attendant information detected in Step b3 in FIG. 9 is chosen out of the traveling history data stored in the traveling history database 202 based on the attendant ID history data in the attendant ID database 102. For example the user is accompanied by the attendant “aaa.co.jp” again, the history data (1) and (2) in FIG. 10 are chosen, and the number of M is four (since the same traveling history data being seen twice a month).

Step b52 is a step for extracting traveling history data not related to the current attendant. The traveling history data of attendant attribute <PersonWith> not including the attendant information detected in Step b3 in FIG. 9 is chosen out of the traveling history data stored in the traveling history database 202 based on the attendant ID history data in the attendant ID database 102. For example the history data (3) and (4) in FIG. 11 are chosen, and the number of N is four (since the same traveling history data being seen twice a month)

Step b53 is a step for comparing the attribute values between traveling history data. All of the attribute values are compared about the attribute other than the attendant attribute on all of the combinations of M pieces of “traveling history data related to the current attendant” extracted in Step b51 and N pieces of “traveling history data not related to the current attendant” extracted in Step b52 (4×4=16 combinations in this case). In an example in FIG. 11, the comparison is performed on <Time> and <Location>. The comparison on the attribute <Time> may be performed for identical match in “time slot” (for example. between 10 and 11 o'clock) and “day of the week” or the comparison may be performed by considering “a predetermined range of time difference is regarded as identical (for example. ±10 mins.)”. And also the comparison for <Location> may be performed considering that the character string is identical for postal code and name of landmark, and a predetermined range of longitude and latitude difference is regarded as identical for the longitude and latitude information obtainable from GPS.

Step b54 is a step for judging a traveling history data which is particular to the current attendant. The traveling history data is judged as “a traveling history data particular to the current attendant”, where at least one of the attribute values is judged as different attribute value in the attribute value comparison in Step b53 out of M pieces of “traveling history data related to the current attendant” extracted in Step b51. In the example in FIG. 11, the history data (1) and (2) are the traveling history data particular to the current attendant because the <Location> is not identical.

Step b55 is a step for judging a traveling history data related to the current traveling history data. The history data related to the current traveling history data is chosen out of the traveling history data judged as “traveling history data particular to the current attendant” in Step b54. More specifically, regarding attribute value <Location>, the traveling history data is chosen, where “traveling history data of the current user” and “traveling history data particular to the current attendant” are identical by comparison. And then the traveling history data which is subsequent to the traveling history data chosen is judged as the next destination where the user visits with the current attendant afterward. In the example in FIG. 11, it is predicted that when the current user is in a coffee shop with the attendant “aaa.co.jp”, the user goes to a cinema with the attendant from the history data (2). The information related to movies, therefore, is provided, and also the location of the cinema where the movie is shown can be set up in a car navigation system. This information providing method is just an example, and when plural <Location> are chosen, the information on the destination with more frequency can be recommended. Or the plural past traveling history data of that day can be reflected for decision. For example, when there are plural available recommendations such as boutiques and cinemas as the destination after a coffee shop, the plural places where the user visited before the coffee shop are taken into consideration. For example it can be analyzed that the user visits more frequently to a cinema after visiting a bookstore followed by a department store in the history data. And then the next destination is predicted and the related information is provided. If the traveling history data related to the current traveling history data is available, the operation proceeds to Step b6 in FIG. 9, and unless the traveling history data related to the current traveling history data is available, the operation proceeds to Step b7 in FIG. 9.

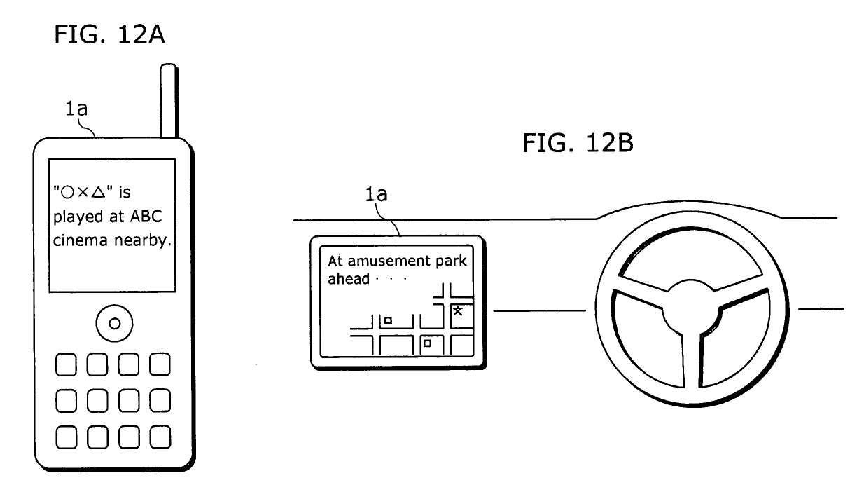

As mentioned above, according to the second embodiment, the services that are appropriate to the destination for the user with an attendant can be provided, by means of specifying the destination particular to the user with the specific attendant instantly after the user meets the attendant. For example, a screen display on a cellular phone 1a is shown in FIG. 12 A, if the user being accompanied by an attendant searches for information on a recommended place for pleasure using the cellular phone 1a, it is shown that the information on the places where the user frequently visits with the specific attendant (for example. movie information shown in a cinema) in the screen. And also the screen display on a car navigation 1a in FIG. 12A shows the information on the places where the user frequently visits with the specific attendant at the moment when the user gets on the car with the attendant (for example. information on an amusement park).

### The Third Embodiment

In the third embodiment, it is considered to provide the user and the attendant with services depending on the place where the user with the attendant is located and the service utilization history data by specifying the service utilization activity that is particular to the user with an attendant.

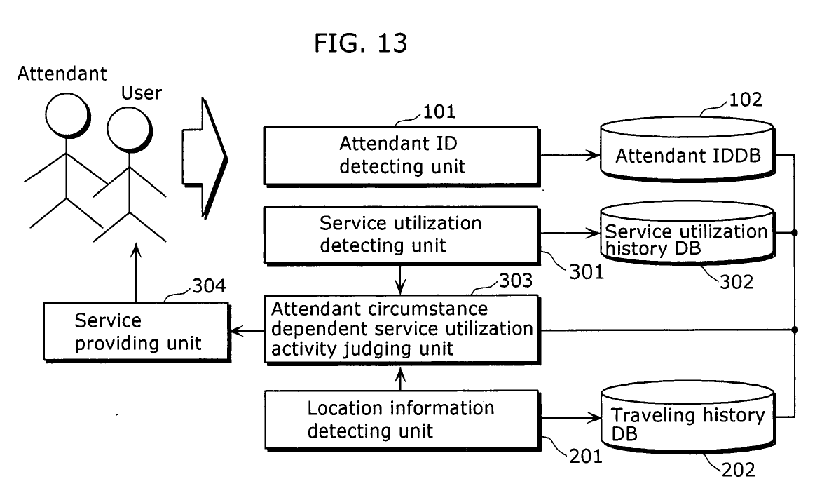

The configuration of the attendant circumstance utilization device 100 in the third embodiment is shown in FIG. 13. The attendant circumstance utilization device 100 in FIG. 13 includes an attendant ID detecting unit 101, an attendant ID database 102, a location information detecting unit 201, a traveling history database 202, a service utilization detecting unit 301, a service utilization history database 302, an attendant circumstance dependent service utilization activity judging unit 303 and a service providing unit 304. The attendant ID detecting unit 101 detects attendant information (attendant ID) indicating by whom the user, carrying the terminal 1a for example, is accompanied. The attendant ID database 102 stores detected attendant ID history data. The location information detecting unit 201 detects the current location of the user. The traveling history database 202 stores the detected traveling history data for the user. The service utilization detecting unit 301 detects the services which the user used. The service utilization history database 302 stores the detected service utilization history data of the user. The history data of the attendant ID, traveling history data of the user and the service utilization history data are associated each other by the time of detection. The attendant circumstance dependent service utilization activity judging unit 303 judges the service utilization activity which is particular to the user in the case where the user has stayed with the current attendant at the current location where the user stayed before. The judgment is performed on the basis of the attendant ID newly detected by the attendant ID detecting unit 101, the user's current location newly detected by the location information detecting unit 201, the history data of the attendant ID stored in the attendant ID database 102, the traveling history data stored in the traveling history database 202 and the traveling history data stored in the service utilization history database 302. Subsequently the service providing unit 304 provides the user with services depending on the service utilization activities particular to the case when the user has stayed with the current attendant at the current location where the user stayed before.

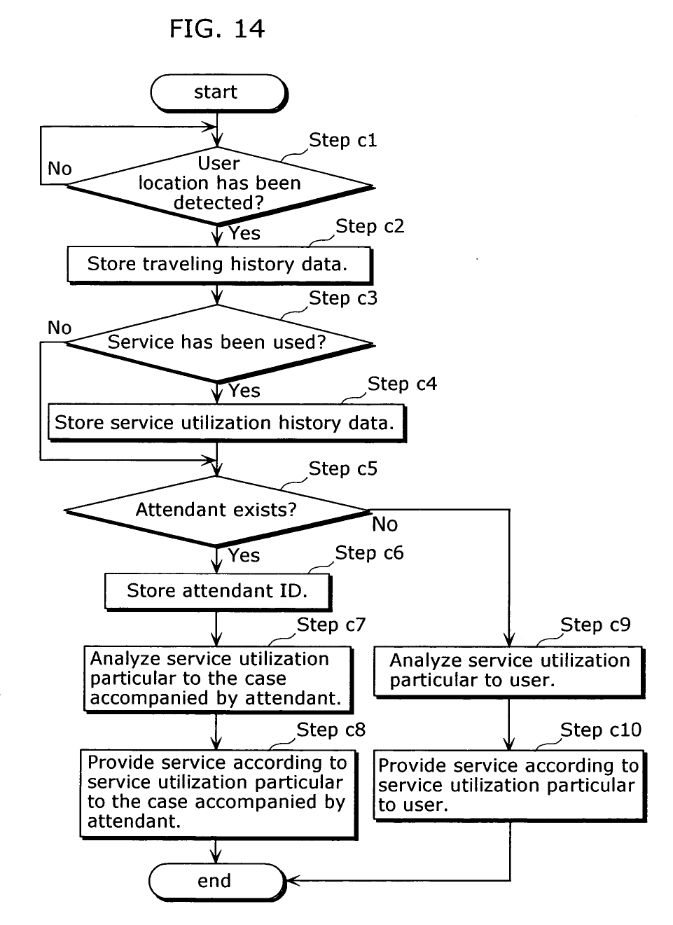

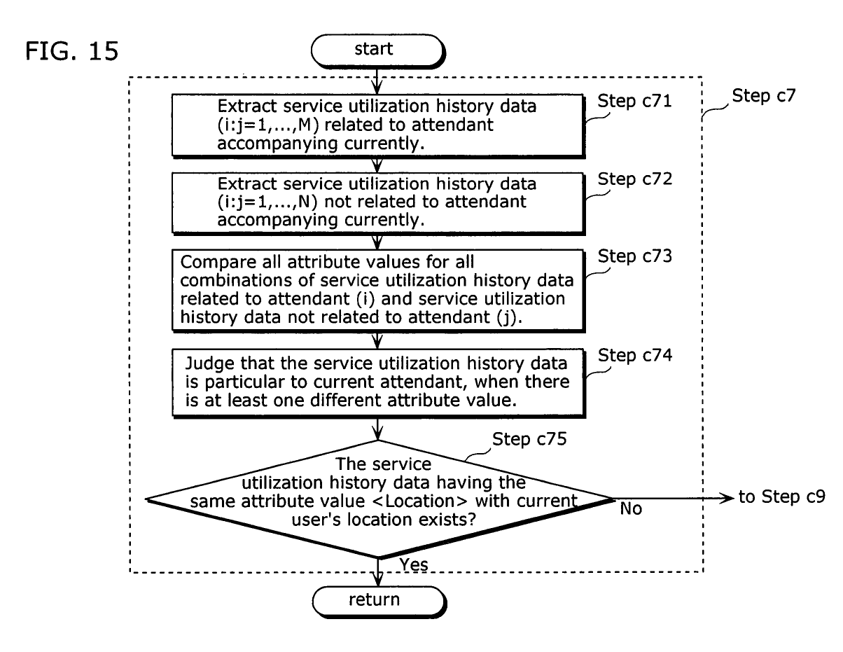

The operation of the third embodiment configured as above now will be explained using the flowcharts in FIG. 14 and FIG. 15.

Step c1 in FIG. 14 is a detecting step of the user location. The location information detecting unit 201 detects the user's location information (current location), as is the case with the second embodiment. When the user's location is detected, the operation proceeds to Step c2, and unless the location is detected, the device remains on standby status for location detection.

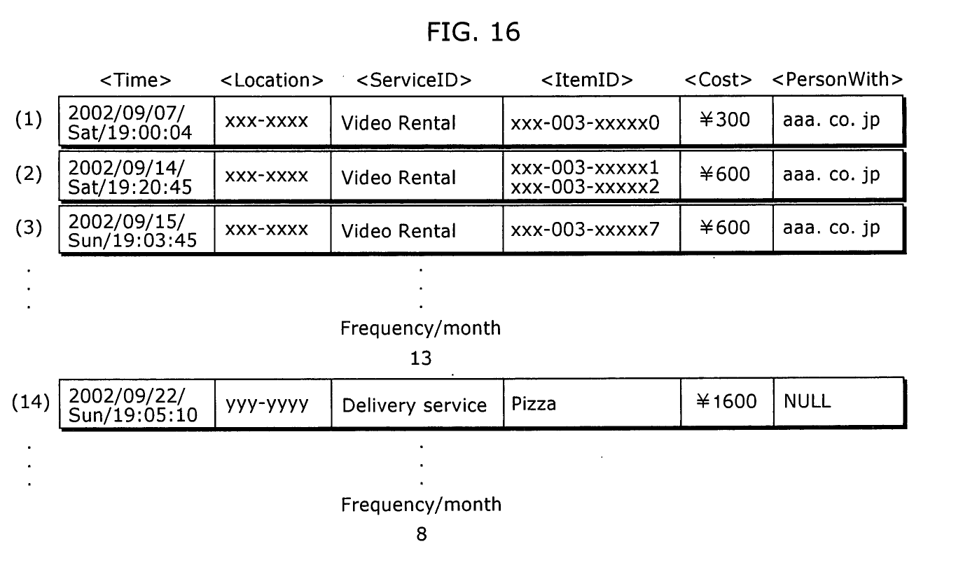

Step c2 is a step for saving the traveling history data. The location information detected in Step c1 is stored in the traveling history database 202. An example (<Time> and <Location>) of the history data stored in the traveling history database 202 is shown in FIG. 16.

Step c3 is a detecting step of the service utilization. The service utilization detecting unit 301 detects a service used by the user.

Step c4 is a saviing step of the service utilization history data. The service utilization history data detected in Step c3 is stored in the service utilization history database 302. An example of the history data (<ServiceID>, <ItemID> and <Cost>) stored in the service utilization history database 302 is shown in FIG. 16. In the history data (1) to (3), the <ServiceID> shows that the user uses video rental service.

Step c5 is a step for detecting an attendant. The attendant ID detecting unit 101 detects the existence or non-existence of an attendant as is the case with the second embodiment. When an attendant is detected, the operation proceeds to Step c6, unless the user has an attendant, the operation proceeds to Step c9.

Step c6 is a saving step of an attendant ID. The attendant information detected in Step c5 is stored in the attendant ID database 102 by associating with the traveling history data stored in the traveling history database 202 by the time of the detection and the service utilization history data stored in the service utilization history database 302, as shown in <PersonWith> in FIG. 16. The history data (1) in FIG. 16, for example, represents that the user rent (<ServiceID> video Rental) a video (<ItemID> xxx-030-xxxxx) with a cost (<Cost> Y300) with an attendant (<PersonWith> aaa.co.jp) at a location (<Location> xxx-xxxx) at a time (<Time>2002/09/07/Sat/19:00:04).

Step c7 is a step for analyzing a service utilization particular to the user with an attendant. The attendant circumstance dependent service utilization activity judging unit 303 specifies the service utilization activity, which is particular to the user with an attendant holding a detected ID, and the operation proceeds to Step c8. In FIG. 16, the frequency of the video rental service (Frequency/Month) utilization is 13 times per month, and it is observed that when the user is accompanied by an attendant “aaa.co.jp”, the frequency is very high. The processing of Step c7 will be described in another section hereinafter.

Step c8 is a step for providing appropriate services depending on the location and the service utilization activity particular to the user with an attendant. The appropriate services to the particular location and the service utilization which are specified in Step c5 are provided. For example a coupon for a video in a genre rent frequently can be delivered timely to the terminal 1a carried by the user, when the user is located near the video rental store with the attendant “aaa.co.jp”, by managing the service utilization history data, the user location and the attendant ID in the service provider 5.

Step c9 is a step for analyzing the service utilization activity which is particular to the user without attendant. The attendant circumstance dependent service utilization activity judging unit 303 specifies a service utilization activity particular to the user, and the operation proceeds to Step c10. Regarding the service utilization particular to the user, “NULL” in attendant attribute <PersonWith> is chosen. And then the history data is chosen, where “current user service utilization history data” and “past user service utilization history data” are identical by comparing the attribute values <Location>, and the stored attribute value <ServiceID> is specified at the same time as the service utilization particular to the user at the location.

Step c10 is a step for providing appropriate services depending on the service utilization activity particular to the user. Since the user is unaccompanied, the services related to the location and the service utilization activity particular to the user are provided.

The procedure in Step c7 above to specify the service utilization activity particular to the user with an attendant now will be described using the flowchart in FIG. 15. The processes below are all performed by the attendant circumstance dependent service utilization activity judging unit 303. The processing in FIG. 15 is subject to be executed after the existence of an attendant is confirmed in Step c5 in FIG. 14.

Step c71 is a step for extracting the service utilization history data related to the current attendant. The service utilization history data of identical attribute value <PersonWith> with the attendant information detected in Step c5 in FIG. 14 is chosen out of the service utilization history data stored in the service utilization history database 302 based on the attendant ID history data in the attendant ID database 102. For example when the user is accompanied by the attendant “aaa.co.jp” again, the history data (1), (2), (3) and so on in FIG. 16 are chosen, and thus the number of M is 13 (since there are 13 times of the same service utilization history data per month).

Step c72 is a step for extracting the service utilization history data not related to the current attendant. The service utilization history data of the attendant attribute <PersonWith> not including the attendant information detected in Step c5 in FIG. 14 is chosen out of the service utilization history data stored in the service utilization history database 302 based on the attendant ID history data in the attendant ID database 102. For example the history data (14) and so on is chosen, which is related to pizza (Pizza) delivery service (Delivery service) in FIG. 16, and thus the number of N is eight (since there are eight times of the same service utilization history data per month)

Step c73 is a step for comparing attribute values between service utilization history data. All of the attribute values are compared about the attribute other than the attendant attribute (13×8=104 combinations in this case) on all of the combinations of M pieces of “the service utilization history data related to the current attendant” extracted in Step c71 and N pieces of “the service utilization history data not related to the current attendant” extracted in Step c72. In an example in FIG. 16, the comparison on <Time>, <Location>, <Service ID>, <ItemID> and <Cost> are performed. The comparison on the attribute <Time> may be performed for identical match for “time slot” (for example. between 19 and 20 o'clock) and “day of the week” or the comparison may be performed by considering “a predetermined range of time difference is regarded as identical (for example. ±10 min.). And also the comparison for <Location> may be performed considering that the identical match of the character string is identical for postal code and name of landmark, and a predetermined range of longitude and latitude difference is considered as identical for the longitude and latitude information obtainable from GPS. While, regarding <Cost>, a predetermined range of rate difference may be allowed to consider as identical, otherwise exact match judgment may be performed.

Step c74 is a step for judging the service utilization history data particular to the current attendant. A service utilization history data is judged as “service utilization history data particular to the current attendant”, when the service utilization history data is judged that at least one of the attribute value is different in attribute value comparison in Step c73 out of the M pieces of “the service utilization history data related to the current attendant” extracted in Step c71. In an example in FIG. 16, it is judged that at least the history data (1), (2) and (3) are the service history data particular to the current attendant, since <Location>, <ServiceID>, <ItemID> and <Cost> are not identical. And when the user is accompanied by “aaa.co.jp”, it is specified that the user and the attendant go to a location “xxx-xxxx” at around 19 o'clock and utilize a video rental service to rent a video of genre 003.

Step c75 is a step for judging the service utilization history data related to the current traveling history data. The history data related to the user's current location <Location> is chosen out of the history data judged as “the service utilization history data particular to the current attendant” in Step b54. More specifically, firstly the identical history data are chosen by comparing “the traveling history data of the current user” and “the traveling history data particular to the current attendant” for the attribute value <Location>. And then the service utilization saved in the history data chosen is specified as the specific service used at the current location when the user is accompanied by the current attendant. In an example in FIG. 16, when it is detected that the user is accompanied by the attendant “aaa.co.jp” and is located near the location “xxx-xxxx” currently, a video rental service, which is frequently used by them, is specified. And the information is notified to a video rental store and the service provider 5 to which the video rental store subscribes, and also if the service provider 5 manages the service utilization history data, the user location and the attendant ID, a coupon of a video in a genre rent frequently can, therefore, be delivered timely to the terminal 1a carried by the user, when it is detected that the user is accompanied by the user “aaa.co.jp” and is located near the video rental store. When there is a service utilization history data related to the current traveling history data, the operation proceeds to Step c8 in FIG. 14, and unless there is a service utilization history data, the operation proceeds to Step c9 in FIG. 14.

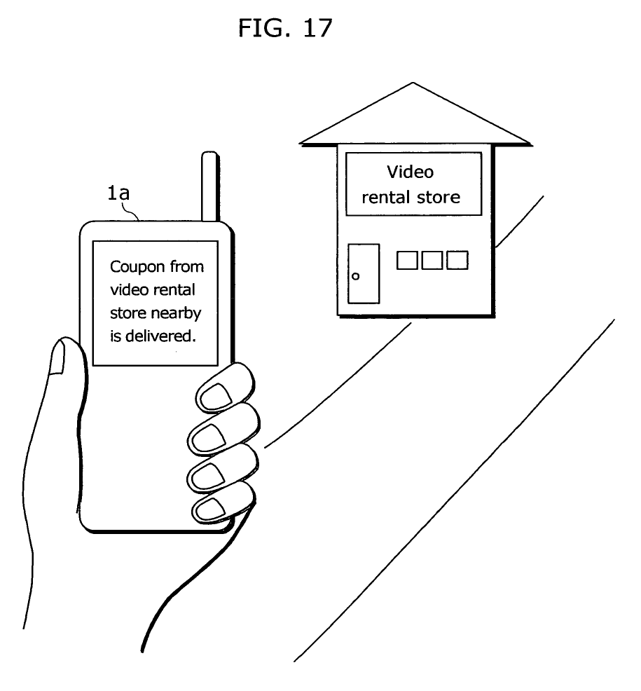

As described above, in the third embodiment, it is possible to timely provide the frequently used service at the frequently visiting location with the attendant by specifying the attendant, the current location and the service utilization history data. For example, as shown in the screen display of the cellular phone 1a in FIG. 17, when the user is accompanied by the attendant and is located near the video rental store, a coupon etc. of a video in a genre which the user and the attendant rent frequently at the video rental store is delivered to the cellular phone 1a carried by the user through e-mail and so on.

### The Fourth Embodiment

In the fourth embodiment, it is considered that the user and the attendant are able to obtain appropriate information depending on the category of the attendant by notifying the service provider 5 of the category of the attendant with the user. For example, the user notifies the service provider 5 of the category of the current attendant (choosing from friend, boss and family so on) and the current location, and for example a coupon from a nearby store (for example. restaurant) suitable for the category can be delivered.

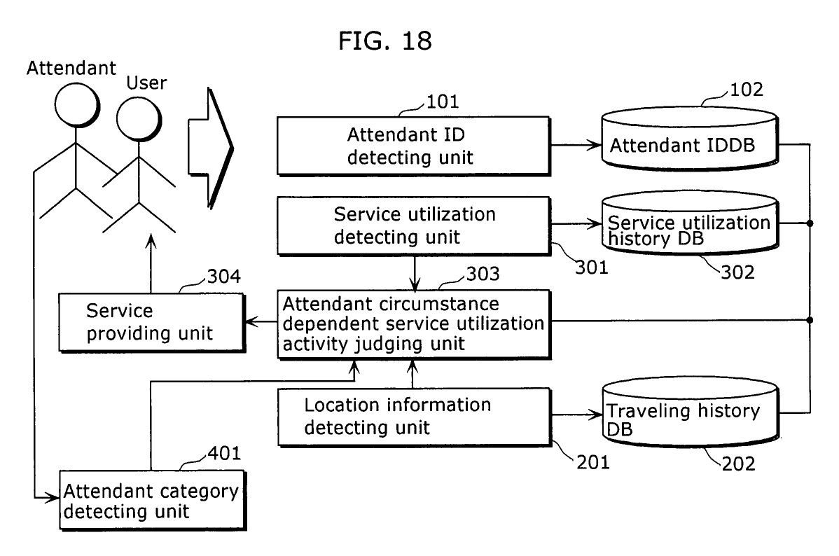

The configuration of the attendant circumstance utilization device 100 in the fourth embodiment is shown in FIG. 18. The difference between FIG. 13 for the third embodiment and FIG. 18 is that an attendant category detecting unit 401 is added to detect the attendant category information.

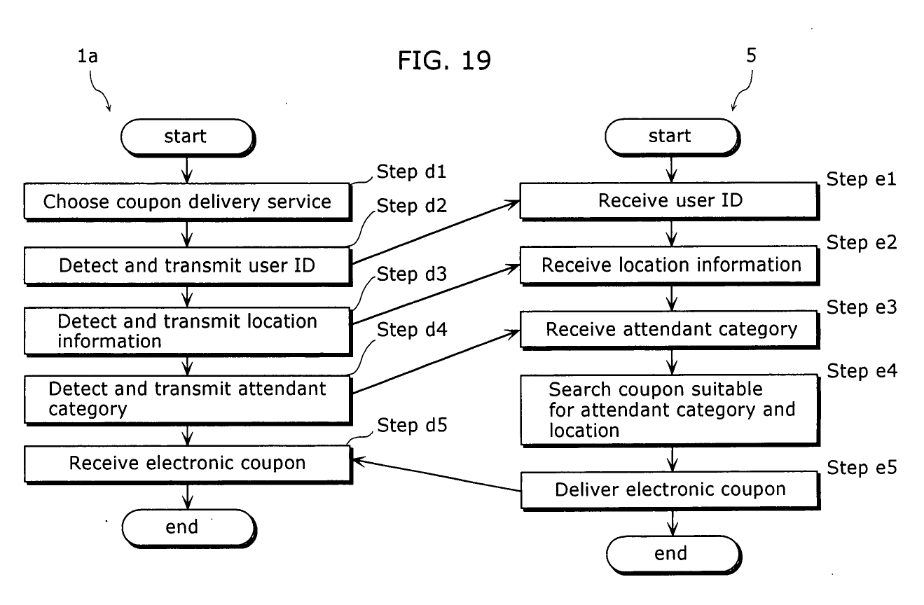

The operation of the fourth embodiment configured as above now will be explained using the flowchart in FIG. 19. At the user terminal 1a, in Step d1, the user accesses to WAN 3 with the own terminal 1a, and then for example the user chooses a homepage of coupon delivery. In this step, the user ID, the current location information and the category of the attendant are detected respectively and transmitted to the service provider 5 in Step d2 to Step d4. On the other hand, the service provider 5 receives respectively the user ID, the current location information and the category of the attendant transmitted from the user terminal 1a in Step e1 to Step e3. And then the service provider 5 searches an electronic coupon available depending on the attendant category and the current location in Step e4. Once an electronic coupon suitable for the attendant category and the current location is searched out, the coupon is delivered to the user terminal 1a in Step e5, while the user terminal 1a receives the coupon in Step d5.

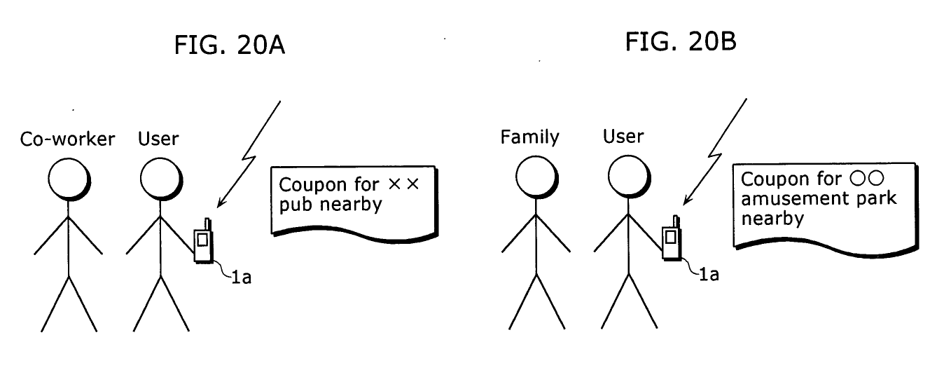

As described above, according to the fourth embodiment, by means of notifying the service provider 5 of the category of the attendant of the user, the user is able to obtain appropriate information depending on the category of the attendant. For example, like the screen display of a cellular phone 1a in FIG. 20, by notifying the service provider 5 of that the user is accompanied by a co-worker using the cellular phone 1a, a coupon which can be used at a pub nearby is delivered to the cellular phone 1a by electronic mail (FIG. 20A). Also by notifying the service provider 5 of that the user is accompanied by family, a coupon which can be used at an amusement park nearby is delivered to the cellular phone 1a by electronic mail (FIG. 20B).

### The Fifth Embodiment

In the fifth embodiment, it is considered that the user and the attendants are able to obtain appropriate information depending on the number of attendants by notifying service provider 5 of the number of attendants with the user. For example, when the number of attendants and the current location are notified to the service provider 5, the services can be provided such as notification of the table availability of a restaurant and delivery of coupons for that group size.

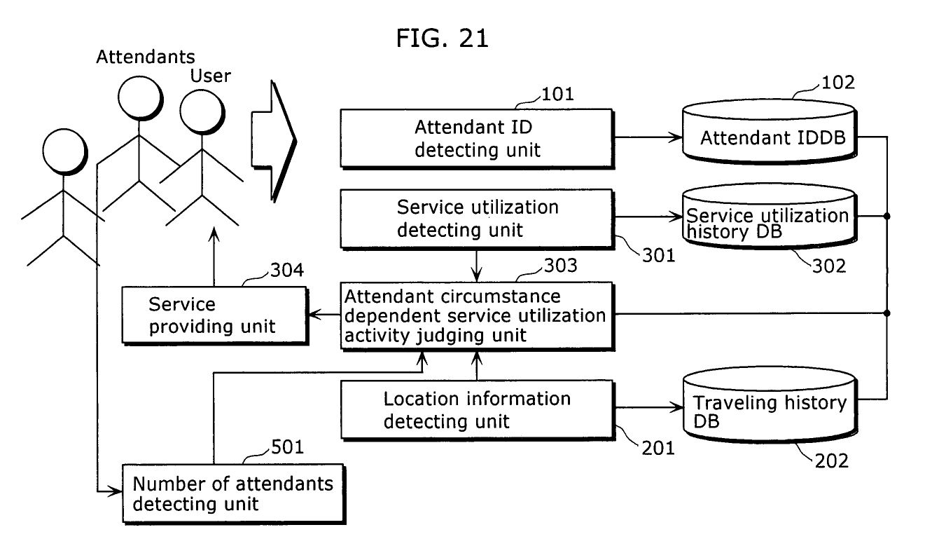

The configuration of the attendant circumstance utilization device 100 in the fifth embodiment is shown in FIG. 21. The difference between the third embodiment in FIG. 13 and the fifth embodiment in FIG. 21 is that the number of attendants detecting unit 501 is added.

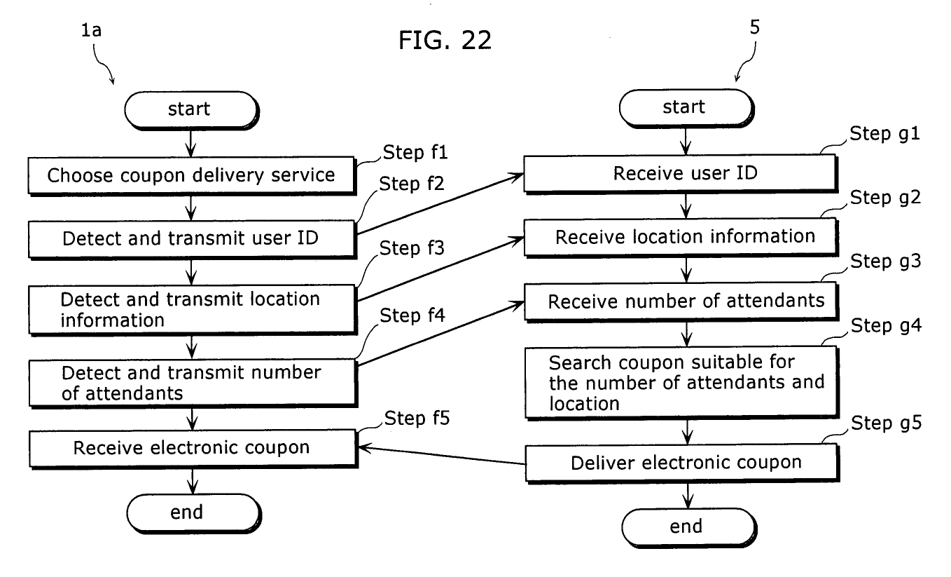

The operation of the fifth embodiment configured as above now will be described with a flowchart in FIG. 22. At the user terminal 1a, in Step f1, the user accesses to WAN 3 with user's own terminal 1a. For example, a homepage for coupon delivery is chosen. In this step, in Step f2 to Step f4, the user ID, the current location information and the number of the attendants are detected respectively and are transmitted to the service provider 5. On the other hand, the service provider 5 receives the user ID, the current location information and the information on the number of the attendants respectively transmitted from the user terminal 1a in Step g1 to Step g3. Then the service provider 5 searches for available electronic coupons depending on the number of attendants and the current location in Step g4. Once an electronic coupon appropriate to the number of attendants and the current location is found, the coupon is transmitted to the user terminal 1a in Step g5. And the user terminal 1a receives the coupon in Step f5.

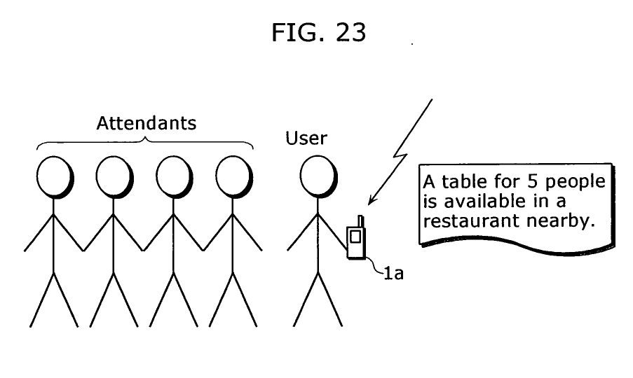

As described above, according to the fifth embodiment, by notifying the service provider 5 of the number of attendants with the user, the services depending on the number of attendants can be provided. The screen display on the cellular phone 1a shown in FIG. 23 is an example. If the user notifies the service provider 5 of that the user is accompanied by four attendants by the cellular phone 1a, the information is delivered to the cellular phone 1a, which recommends available restaurants for 5 people or restaurants offering discount for a group of 5 people and the like.

Hereinbefore, the description of the attendant circumstance utilization device related to the present invention is shown on the basis of five different embodiments, however, the present invention is not limited to these embodiments.

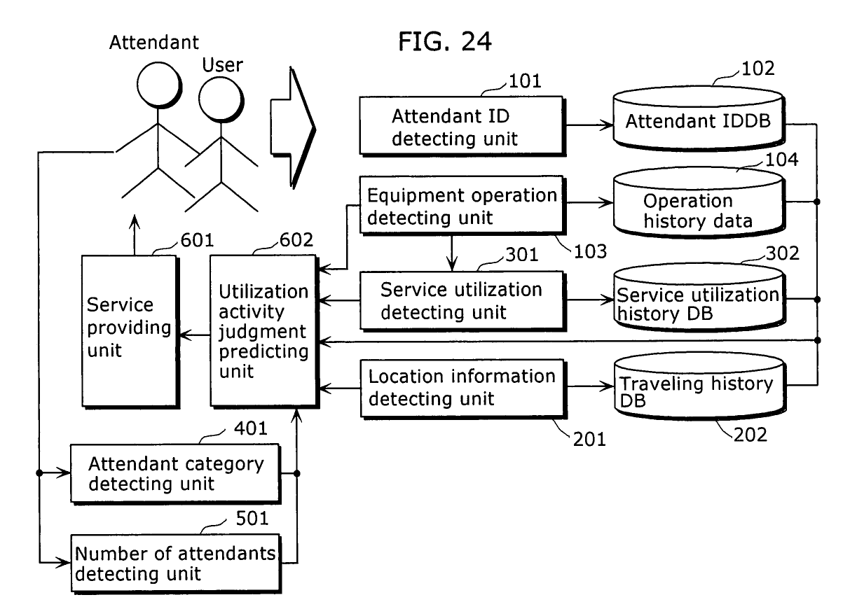

For example, the attendant circumstance utilization device including a configuration by combining these embodiments properly is deemed to be one of the embodiments. As shown in FIG. 24 as an example of a configuration, the present invention may be realized as one of the attendant circumstance utilization device including all of the configuration elements that are included in the attendant circumstance utilization device shown in the first through fifth embodiments. In FIG. 24, a utilization activity judgment predicting unit 602 is a processing unit combining the attendant circumstance dependent operation activity judging unit 105 in the first embodiment, the attendant circumstance dependent traveling predicting unit 203 in the second embodiment and the attendant circumstance dependent service utilization activity judging unit 303 in the third through the fifth embodiments. The service providing unit 601 is a processing unit combining the function/content providing unit 106 in the first embodiment, the service providing unit 204 in the second embodiment and the service providing unit 304 in the third through the fifth embodiments.

The attendant circumstance utilization device related to the present invention is, therefore, to provide a user with the different types of services depending on the activities which are particularly seen in the cases (1) an attendant accompanying a user, (2) a category of an attendant, (3) the number of the attendants, (4) the location of a user, (5) the type of the services which a user uses and (6) any combinations of these cases, in other words (1) user's equipment operation, (2) user's destination and (3) the service which a user used and so on. Those all elements may be properly chosen and determined depending on the type of the devices and the type of the systems and so on applied to the attendant circumstance utilization device related to the present invention.

### INDUSTRIAL APPLICABILITY

The present invention can be used as an attendant circumstance utilization device for controlling an equipment automatically and also for delivering a content and other information to the user's equipment depending on an attendant accompanying a user, for example, the attendant circumstance utilization device is applicable to such as a cellular phone equipment, a car navigation system, a PDA and a home server and so on.

1-11. (canceled)

12. An attendant circumstance utilization device, for providing a user with at least one service from among services including provision of information, setting of equipment and rendering of a service, said device comprising:
an attendant detecting unit operable to detect an attendant accompanying the user;
a circumstance detecting unit operable to detect at least one of: i) a traveling location of the attendant accompanying the user or the user and the attendant accompanying the user, ii) an equipment operation and iii) a utilized service;
a storing unit operable to store attendant information indicating the attendant detected by said attendant detecting unit by associating with at least one of the utilization history data among the traveling location, the equipment operation and the utilized service detected by said circumstance detecting unit; and
a service providing unit operable to determine a service to be provided to the user based on the newly detected attendant by said attendant detecting unit and the utilization history data stored in said storing unit, and to provide the user with the determined service.

13. The attendant circumstance utilization device according to claim 12,
wherein said circumstance detecting unit is operable to detect an equipment operation by the user, and
said storing unit is operable to store history data of the detected equipment operation by associating with the attendant information indicating the attendant detected by said attendant detecting unit when the user performs the equipment operation,
said attendant circumstance utilization device further comprises,
a judging unit operable to judge an equipment operation activity particular to a case, where the user is accompanied by the same attendant at a present time and in a past time, based on the attendant newly detected by said attendant detecting unit and the equipment operation history data stored in said storing unit, and
said service providing unit is operable to execute at least one of provision of information and setting of equipment depending on the particular equipment operation activity.

14. The attendant circumstance utilization device according to claim 12,
wherein said circumstance detecting unit is operable to detect a current location of the user, and
said storing unit is operable to store traveling history data of the user based on the detected current location by associating with the attendant information indicating the attendant detected by said attendant detecting unit when the user performs the traveling,
said attendant circumstance utilization device further comprises,
a judging unit operable to judge a destination particular to a case, where the user is accompanied by the same attendant at a present time and in a past time, based on the user's current location newly detected by said circumstance detecting unit, the attendant newly detected by said attendant detecting unit and the traveling history data stored in said storing unit,
wherein said service providing unit is operable to execute at least one of provision of information and setting of equipment depending on the particular destination.

15. The attendant circumstance utilization device according to claim 12,
wherein said circumstance detecting unit is operable to detect a service which the user utilizes, and
said storing unit is operable to store the detected service utilization history data by associating with an attendant information indicating the attendant detected by said attendant detecting unit when the user utilizes the service,
said attendant circumstance utilization device further comprises,
a judging unit operable to judge a service utilization particular to a case, where the user is accompanied by the same attendant at a present time and in a past time, based on the attendant newly detected by said attendant detecting unit and the utilization history data stored in said storing unit,
wherein said service providing unit is operable to provide the user with at least one service from among services including provision of information, setting of equipment and rendering of a service depending on the particular service utilization.

16. The attendant circumstance utilization device according to claim 15,
wherein said circumstance detecting unit is further operable to detect a current location of the user,
said storing unit is operable to store the traveling history data of the user based on the detected current location by associating with the utilization history data and the attendant information,
said judging unit is operable to judge a service utilization particular to a case, where the user is accompanied by the same attendant and also is located at the same location at a present time and in a past time, based on the current location of the user newly detected by said circumstance detecting unit, the attendant newly detected by said attendant detecting unit and the utilization history data stored in said storing unit, and
said service providing unit is operable to provide the user with at least one service from among services including provision of information, setting of equipment and rendering of a service depending on the particular service utilization.

17. The attendant circumstance utilization device according to claim 12,
wherein said circumstance detecting unit is operable to detect a service which the user utilizes and also to detect a category of the attendant,
said storing unit is operable to store the detected service utilization history data by associating with the category information indicating the category newly detected by said circumstance detecting unit when the user utilizes the service,
said attendant circumstance utilization device further comprises,
a judging unit operable to judge a service utilization particular to a case, where the category of the attendant accompanying the user is the same at a present time and in a past time, based on the category newly detected by said circumstance detecting unit and the utilization history data stored in said storing unit,
said service providing unit is operable to provide the user with at least one service from among services including provision of information, setting of equipment and rendering of a service depending on the particular service utilization.

18. The attendant circumstance utilization device according to claim 17,
wherein said circumstance detecting unit is further operable to detect a current location of the user,
said storing unit is operable to store the traveling history data of the user based on the detected current location by associating with the utilization history data and the category information,
said judging unit is operable to judge a service utilization particular to a case, where the category of the attendant accompanying the user is the same and also is located at the same location at a present time and in a past time, based on the current location of the user newly detected by said circumstance detecting unit, the attendant category newly detected by said circumstance detecting unit and the utilization history data stored in said storing unit, and
said service providing unit is operable to provide the user with at least one service from among provision of information, setting of equipment and rendering of a service depending on the particular service utilization.

19. The attendant circumstance utilization device according to claim 12,
wherein said circumstance detecting unit is operable to detect a service which the user utilizes and to detect the number of the attendants, and
said storing unit is operable to store utilization history data of the detected service by associating with the number information indicating the number detected by said circumstance detecting unit when the user utilizes the service,
said attendant circumstance utilization device further comprises,
a judging unit operable to judge a service utilization particular to a case, where the number of the attendants accompanying the user is the same at a present time and in a past time, based on the number newly detected by said circumstance detecting unit and the utilization history data stored in said storing unit,
said service providing unit is operable to provide the user with at least one service from among services including provision of information, setting of equipment and rendering of a service depending on the particular service utilization.

20. The attendant circumstance utilization device according to claim 19,
wherein said circumstance detecting unit is further operable to detect a current location of the user,
said storing unit is operable to store the traveling history data of the user by associating with the utilization history data and the number information based on the detected current location,
said judging unit is operable to judge a service utilization particular to a case, where the number of the attendants accompanying the user is the same and also the user is located at the same location at a present time and in a past time, based on the current location of the user newly detected by said circumstance detecting unit, the number of attendants newly detected by said circumstance detecting unit and the utilization history data stored in said storing unit, and
said service providing unit is operable to provide the user with at least one service from among services including provision of information, setting of equipment and rendering of a service depending on the particular service utilization.

21. An attendant circumstance utilization method, for providing a user with at least one service from among services including provision of information, setting of equipment and rendering of a service, comprising:
an attendant detecting step of detecting an attendant accompanying the user;
a circumstance detecting step of detecting at least one of: i) a traveling location of the attendant accompanying the user or the user and the attendant accompanying the user, ii) an equipment operation and iii) a utilized service;
a storing step of storing, into a storage unit, an attendant information indicating the attendant detected by said attendant detecting step by associating with at least one of utilization history data from among a traveling location, an equipment operation and a utilized service detected by said circumstance detecting step; and
a service providing step of determining a service to be provided to the user based on an attendant newly detected by said attendant detecting step and the utilization history data stored into the storage unit, and of providing the user with the determined service.

22. A program, used for a device which provides a user with at least one service from among services including provision of information, setting of equipment and rendering of a service, said program causing a computer to execute:
an attendant detecting step of detecting an attendant accompanying the user;
a circumstance detecting step of detecting at least one of: i) a traveling location of the attendant accompanying the user or the user and the attendant accompanying the user, ii) an equipment operation and iii) a utilized service;
a storing step of storing, into a storage unit, an attendant information indicating the attendant detected by said attendant detecting step by associating with at least one of utilization history data from among a traveling location, an equipment operation and a utilized service detected by said circumstance detecting step; and
a service providing step of determining a service to be provided to the user based on an attendant newly detected by said attendant detecting step and a utilization history stored into the storage unit, and for providing the user with the determined service.

23. The attendant circumstance utilization device according to claim 13,
wherein said judging unit is operable to judge an operation activity of choosing a content, which is utilized only in the case of a combination of the user and an attendant newly detected by said attendant detecting unit, as the equipment operation activity,
said service providing unit is operable to provide the user with a content choice by an attribute as the service.

24. The attendant circumstance utilization device according to claim 13,
wherein said judging unit is operable to judge a setting operation activity for an equipment, which comes about only in the case of a combination of the user and an attendant newly detected by said attendant detecting unit, as the equipment operation activity.

25. The attendant circumstance utilization device according to claim 13,
wherein said judging unit is operable to judge a function choice activity for an equipment, which come about only in the case of a combination of the user and an attendant newly detected by said attendant detecting unit, as the equipment operation activity.
